(19) United States
(12) Patent Application Publication
(10) Pub. No.: US 2026/0095516 A1
(43) Pub. Date: Apr. 2, 2026

(54) Method for User Equipment, Apparatus and Computer Program

(71) Applicant: Bayerische Motoren Werke AKtiengesellschaft, Muenchen (DE)

(72) Inventors: Thorsten KNOTT, Tuntenhausen (DE); Daniel KUELZER, Muenchen (DE); Alaa MOURAD, Muenchen (DE)

(21) Appl. No.: 19/115,002

(22) PCT Filed: Nov. 22, 2022
(86) PCT No.: PCT/EP2022/082869

§ 371 Date: Mar. 25, 2025

(51) Int. Cl. H04L 69/28; H04W 52/02

(52) U.S. Cl. CPC H04L 69/28; H04W 52/0251

(57) ABSTRACT

Embodiments of the present disclosure relate to a method for user equipment for adjusting a Bluetooth low energy connection interval with a communication device. In one form a method comprises obtaining connection data indicative of a desired adjustment of the connection interval and adjusting the connection interval between the user equipment and the communication device based on the connection data.

### BACKGROUND AND SUMMARY

The present disclosure relates to the field of Bluetooth communication. Embodiments relate to a method for user equipment, method for a communication device, an apparatus, vehicle and a computer program.

Functions requiring physical proximity between two Bluetooth low energy (BLE) communication participants may have a connection without physical proximity. The corresponding energy consumption depends on the BLE connection interval, which is a time the next message exchange is scheduled. The lower the connection interval, the higher the energy consumption. Thus, there may be a need to improve the BLE communication.

It is therefore a finding that a BLE communication can be improved by adjusting the connection interval between user equipment and communication device. For this, connection data is obtained by user equipment to adjust the connection interval based on the connection data.

Examples provide a method for user equipment for adjusting a Bluetooth low energy connection interval with a communication device. In one form, a method comprises obtaining connection data indicative of a desired adjustment of the connection interval. Further, the method may comprise adjusting the connection interval between the user equipment and the communication device based on the connection data. In this way, the connection interval of the BLE communication can be adjusted to a current need. Thus, an energy consumption can be reduced. For example, the connection interval may be increased (resulting in a decreased energy consumption) if a certain distance between the user equipment and the communication device is exceeded.

In an example, the connection data may be indicative of a distance between the user equipment and the communication device, a location of the user equipment, a location of the communication device, an interference of the BLE communication between the user equipment and the communication device and/or a motion of the user equipment. In this way, an adjustment of the connection interval can be associated with different boundary conditions. For example, the connection interval can be decreased when a motion of the user equipment is determined.

In an example, the method may further comprise determining the desired adjustment based on a distance between the user equipment and the communication device. Further, the method may comprise obtaining distance data indicative of a distance between the user equipment and the communication device and comparing the distance data with a threshold and adjusting the connection interval if the threshold is exceeded or undercut. In this way, the connection interval can be adjusted to consider the distance between the user equipment and the communication device. Thus, the connection interval can be decreased if the user equipment is close to the communication device or approaches the communication device or can be increased if the user equipment is far away from the communication device or moves away, for example.

In an example, the connection interval may be increased or decreased based on the connection data. In this way, an adjustment of the connection interval can be facilitated.

In an example, the method may further comprise obtaining usage data indicative of the usage of the adjusted connection interval and resetting the connection interval based on the usage data. By obtaining usage data, e.g., a usage time and/or a usage location can be determined. The connection interval can be adjusted to a value different from a default value.

For example, after a certain time the connection interval can be reset to the default value. In this way, an adjustment of the connection interval can be associated with the current usage.

In an example, the method may further comprise transmitting an adjustment signal indicative of the adjustment of the connection interval to the communication device. In this way, the user equipment can inform the communication device, e.g., a vehicle comprising the communication device, about the adjusted connection interval. Thus, the communication device can adjust the connection interval.

Examples provide a method for a communication device for adjusting a BLE connection interval with user equipment. The method comprises receiving an adjustment signal indicative of an adjustment of the connection interval from the user equipment and adjusting the connection event interval between the user equipment and the communication device based on the adjustment signal. In this way, the communication device can be informed about an adjustment of the connection interval. Thus, the communication device can perform certain measures to adjust the connection interval, e.g., adjust the connection interval for its BLE communication with the user equipment.

Examples relate to an apparatus, comprising interface circuitry configured to communicate with at least one of a communication device or user equipment and processing circuitry configured to perform a method as described above. Examples relate to a vehicle, comprising an apparatus as described above.

Examples further relate to a computer program having a program code for performing the method described above, when the computer program is executed on a computer, a processor, or a programmable hardware component.

### BRIEF DESCRIPTION OF THE DRAWINGS

Some examples of apparatuses, methods and/or computer programs will be described in the following by way of example only, and with reference to the accompanying figures, in which:

FIG. 1 shows an example of a method for user equipment;

FIG. 2 shows an example of a method for a communication device;

FIG. 3 shows an example of an adjustment of the connection interval for an active mode; and

FIG. 4 shows a block diagram of an example of an apparatus for a vehicle.

### DETAILED DESCRIPTION OF THE DRAWINGS

As used herein, the term “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes”, or “including”, when used herein, specify the presence of stated features, integers, steps, operations, elements or components, but do not preclude the presence or addition of one or more other features, integers, steps, operations, elements, components or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

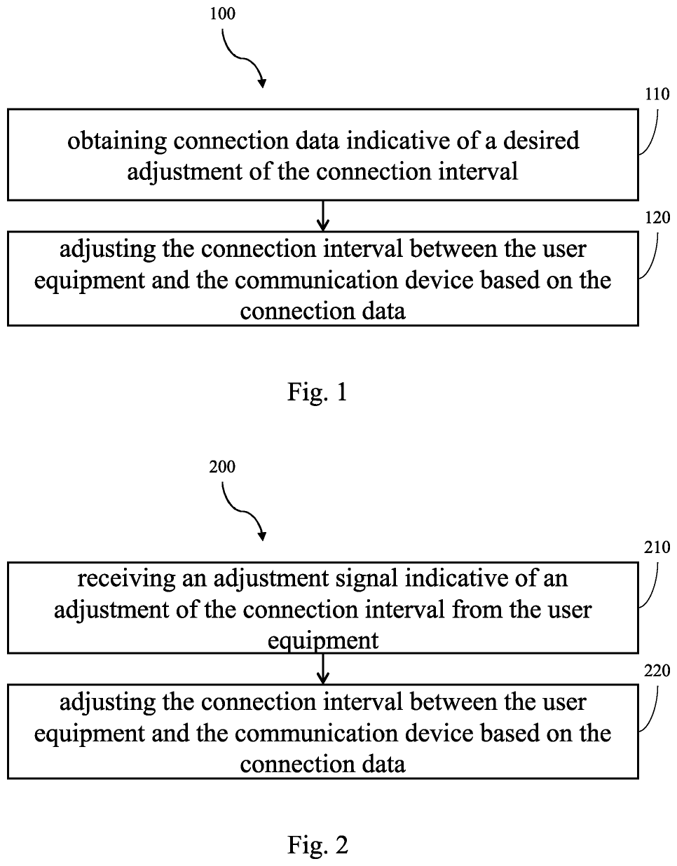

FIG. 1 shows an example of a method 100 for user equipment. The method 100 is for adjusting a BLE connection interval with a communication device. The (BLE) connection interval of a BLE communication may be the interval between two communication signals.

The connection interval may be the time between two connection events and inside each connection event there may be a packet transmission of the BLE communication. A decreased connection interval leads to shorter time between two connection events. Thus, a connection latency may decrease with a decreased connection interval or may increase with an increased connection interval. Therefore, there may be a trade-off between connection latency and energy consumption. The method 100 as described herein could be an industry standard, e.g., part of the Bluetooth standard, or a best practice.

The method 100 comprises obtaining 110 connection data indicative of a desired adjustment of the connection interval. The connection data may be obtained 110 by determining, e.g., by a processing circuitry of the user equipment, and/or by receiving, e.g., via an interface circuitry of the user equipment. For example, the user equipment may determine a distance between the user equipment and the communication device, e.g., based on sensor data such like a LIDAR sensor, a camera, an ultra-wide band sensor. Further, the user equipment may determine the desired adjustment of the connection interval based on the distance. The desired connection interval may increase with increasing distance between user equipment and communication device, for example. For example, the user equipment may receive a connection interval signal indicative of a desired connection interval from the communication device. In this way, the user equipment can adjust the connection interval by request of the communication device. For example, the user equipment may receive information about a current location, e.g., a garage of the owner of the user equipment. Thus, the user equipment can determine the desired adjustment of the connection interval based on the current location.

Further, the method 100 comprises adjusting 120 the connection interval between the user equipment and the communication device based on the connection data. The adjustment of the connection interval can be performed by adjusting a connection interval. By adjusting 120 the connection interval an energy consumption and/or a performance of the BLE connection can be adjusted. For example, by decreasing the connection interval a connection latency can be decreased and thus the performance of the BLE connection can be increased. Alternatively, by increasing the connection interval an energy consumption of the BLE connection can be decreased.

A technical problem of the trade-off between energy consumption and connection latency is described below in the context of digital keys according to the Car Connectivity Consortium, e.g., standard release 3 [1]. However, this is only an example for illustration. The concept of adjusting the connection interval can also be applied to different fields of BLE communication, e.g., user equipment used to open a door, to provide certain functions of a smart home. For example, an illumination of a room in a smart home can be triggered by the communication device based on a position of the user equipment. If the user equipment is at a certain distance to the room the connection interval between the communication device and the user equipment can be decreased to reduce an energy consumption.

For use of digital keys the BLE connection interval should be as low as possible to increase the speed of data exchange, especially in case the user equipment is in physical proximity to the communication device, e.g., the communication device may be part of a vehicle. If the connection interval is large, then, e.g., the UWB ranging session setup handshake among other communication between the user equipment and the communication device is slow. This problem deteriorates when there is a lot of interference in the 2.4 GHz (BLE) band. In those cases, the user might not be able to open the vehicle, or opening is delayed (function degradation), which may decrease a user experience. On the other hand, the device energy consumption depends on the connection interval. In some use cases, e.g., when the user lives close to the vehicle, the phone might be always connected to the vehicle. In this scenario, the 30 ms connection interval (as defined in 19.5.9.2 Enduring RKE Action of [3]) by the CCC for guaranteeing the functionality of vehicle access) might not be necessary. Hence, the problem consists of deciding when to decrease and increase the connection interval. This problem can be solved by obtaining 110 the connection data and adjusting 120 the connection interval based on the connection data.

In an example, the connection data may be indicative of a distance between the user equipment and the communication device, a location of the user equipment, a location of the communication device, an interference of the BLE communication between the user equipment and the communication device and/or a motion of the user equipment. For example, the connection data may be determined by the user equipment e.g., by a sensor of the user equipment such like a motion sensor, a LIDAR sensor. For example the connection data may be received from the communication device or another communication device part of, e.g., an infrastructure of a gas station, a garage of the user of the user equipment. For example, the connection data may be determined by the user equipment, e.g. based on an ultra-wideband communication with the communication device and/or the interference of the BLE communication between the user equipment and the communication device. If there is strong interference of the BLE communication between the user equipment and the communication device the connection interval may be decreased to increase the transmission reliability, e.g., retransmissions. In this way, if there is a high likelihood of needed retransmission caused by high interference the connection data can be indicative of the interference and thus the connection interval can be decreased. For example, an interference of the BLE communication can be determined based on retransmissions of BLE packets. In principle, the connection interval can be increased for an increasing distance between the communication device and the user equipment. For example, the larger the distance between the communication device of the user equipment the longer the connection interval can be.

The connection interval can be adjusted to any number of connection interval (length). For example, there may be two different connection interval 30 ms (for physical proximity between user equipment and communication device, e.g., a distance of at most 20 m, or at most 15 m, at most 10 m or at most 5 m) and 120 ms (for greater distance, e.g., at least 20 m, at least 25 m at least 30m). The condition to adjust, e.g., decrease the connection interval from 120 ms to 30 ms can be determined based on the connection data. For example, a trigger may be defined for adjusting the connection interval. The trigger may be a motion, a non-empty BLE packet received from the communication device, an undercut of the minimal distance between the user equipment and the communication device. The connection data may be indicative of the trigger. Optionally, for guaranteeing the functionality of vehicle access, the decrease in the connection interval should be performed immediately. A motion of the user equipment can be any movement of the user equipment. For example, a motion of the user equipment may depend on a movement threshold, e.g., a motion may be only detected if a user makes two, three or four steps.

Optionally, several triggers can be combined. For example, if a motion of the user equipment was determined a distance measurement of the user equipment can be initiated to determine the distance between user equipment and communication device. If the determined distance exceeds a threshold the connection interval may be decreased. For example, if the user equipment transmits a ranging intent to the communication device, the connection interval can be decreased. In this way, if the user equipment may try to initialize a ranging session, e.g., a reliability of the ranging session can be improved by the decreased connection interval.

Optionally or alternatively, the user equipment can determine a proximity to the communication device. For example, the user equipment can perform a vehicle proximity check based on channel sounding and/or relative signal strength indication. If the proximity check indicates a distance to the vehicle below a threshold the connection interval can be decreased.

Optionally or alternatively, the user equipment can determine the connection data based on a user behavior. For example, if the user of the user equipment approaches the communication device several times in series for unloading the vehicle the connection interval may be adjusted to the user behavior, e.g., the connection interval is decreased and increased in accordance with the approaches of the user. In this way, an energy consumption can be reduced, and the user experience can be kept constant. Alternatively, if the user is unloading the vehicle, he might come back many times and the connection interval can be kept at 30 ms if there were several vehicle unlocks in a short time.

Optionally or alternatively, the user equipment can determine the connection data based on a location, e.g. a GPS position. For example, geofencing and/or point of interest can be used to adjust the connection interval. For example, if the user stops at a gas station, a bakery, a likelihood to (re) enter the vehicle is increased in comparison to a stop at a garage of the user. Thus, the connection interval can be kept at 30 ms for a stop at a gas station, for example.

Optionally or alternatively, the user equipment can determine the connection data based on history of function usage. For example, if the user of the vehicle parks the vehicle in its own garage the connection interval can be adjusted based on a past usage of the vehicle, e.g., the connection interval can be increased. Since human patterns are often repetitive based on the individual user (user of the user equipment) a vehicle entry intention can be learned. This learned vehicle entry intention can be part of the connection data.

Optionally or alternatively, the user equipment can determine the connection data based on data of another sensor not related to BLE communication of the user equipment, e.g., an ultra-wide band sensor, a LIDAR sensor, a camera. For example, the other sensor can be used to determine a distance between the user equipment and communication device. In this way, a determination of the distance can be improved and thus an adjustment of the connection interval can be more reliable. For example, if, e.g., a UWB-based trajectory shows that the user is moving away from the vehicle, the user equipment might increase the connection interval (e.g., to 120 ms).

In an example, the method 100 may further comprise determining the desired adjustment based on a distance between the user equipment and the communication device.

Further, the method 100 may comprise obtaining distance data indicative of a distance between the user equipment and the communication device and comparing the distance data with a threshold and adjusting the connection interval if the threshold is exceeded or undercut. In this way, an adjustment of the connection interval can be facilitated. For example, the threshold may be a minimal distance between the user equipment of the communication device for which the 30 ms connection interval may be used. If the user equipment is within this minimal distance the connection interval can be adjusted to the standard 30 ms connection interval defined in [1]. If the user equipment is not within this minimal distance the connection interval can be increased. The comparison can be performed by a processing circuitry of the user equipment. The threshold may depend on location of the communication device, a usage of the communication device, undesired user experience.

In an example, the connection interval may be increased or decreased based on the connection data. In this way, the connection interval can be adjusted to consider a decreased energy consumption and/or a decreased connection latency. For example, a user may provide an input indicative of a desired performance of the BLE connection.

In an example, the method 100 may further comprise obtaining usage data indicative of the usage of the adjusted connection interval and resetting the connection interval based on the usage data. For example, the usage data may be indicative of a usage time, a usage location. In this way, a resetting of the connection interval can be facilitated. For example, the connection interval may be increased during a stop at a garage.

In an example, the method 100 may further comprise transmitting an adjustment signal indicative of the adjustment of the connection interval to the communication device. In this way, the user equipment can inform the communication device about the adjusted connection interval. Thus, the communication device can adjust the connection interval analogously.

In general, the user equipment may be a device that is capable of communicating wirelessly. In particular, however, the user equipment may be a mobile user equipment, e.g., user equipment that is suitable for being carried around by a user. For example, the user equipment may be a user terminal or user equipment within the meaning of the respective communication standards being used for mobile communication. For example, the user equipment may be a mobile phone, such as a smartphone, or another type of mobile communication device, such as a smartwatch, a laptop computer, a tablet computer, or autonomous augmented-reality glasses.

In general, the communication device may be a device that is capable of communicating wirelessly. For example the communication device may be part of a vehicle, e.g. part of an electronic control unit of the vehicle.

More details and aspects are mentioned in connection with the embodiments described below. The example shown in FIG. 1 may comprise one or more optional additional features corresponding to one or more aspects mentioned in connection with the proposed concept or one or more examples described below (e.g., FIG. 2-4).

FIG. 2 shows an example of a method 200 for a communication device. The method 200 is for adjusting a BLE connection interval with user equipment. The method 200 comprises receiving 210 an adjustment signal indicative of an adjustment of the connection interval from the user equipment and adjusting 220 the connection event interval between the user equipment and the communication device based on the adjustment signal. In this way, the communication device can be informed about an adjustment of the connection interval. Thus, the communication device can perform certain measures to adjust to the adjusted connection interval, e.g., adjust the connection interval for its BLE communication with the user equipment. The communication device may be a counterpart to the user equipment described with reference to FIG. 1.

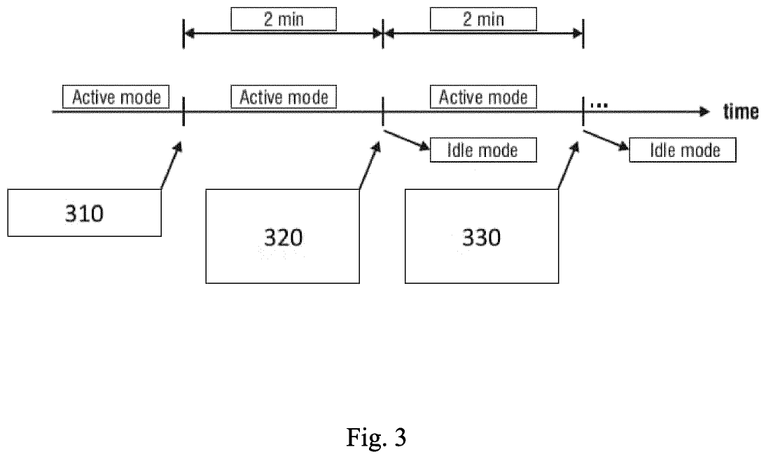

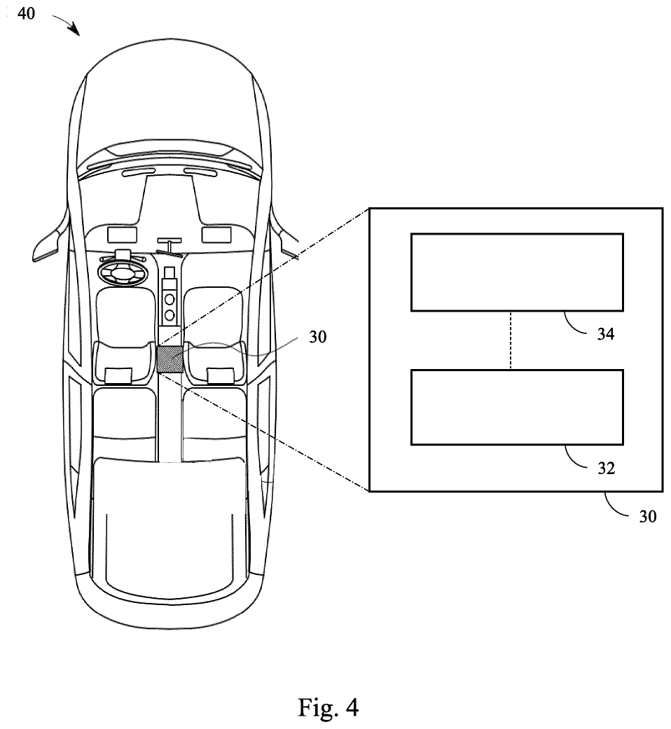

More details and aspects are mentioned in connection with the embodiments described above and/or below. The example shown in FIG. 2 may comprise one or more optional additional features corresponding to one or more aspects mentioned in connection with the proposed concept or one or more examples described above (e.g., FIG. 1) and/or below (e.g., FIGS. 3-4).

FIG. 3 shows an example of an adjustment of the connection interval for an active mode. An active mode can be characterized by a short connection interval, e.g., 30 ms. Thus, the active mode may be to achieve a good connection latency and/or user experience.

For example, after an end of a motion 310 of the user equipment a timeout (e.g., 2 min) may be used to define a time period after which a vehicle proximity check 320, 330 may be performed. The vehicle proximity check 320, 330 may be based on a relative signal strength indicator (of the BLE connection) as described above. Optionally or alternatively, channel sounding may be used. If the vehicle proximity check 320, 330 indicates a distance between the user equipment and the communication device larger than a threshold the connection interval can be adjusted. For example the connection interval can be decreased, such that an idle mode is set. An energy consumption of the BLE connection for the idle mode may be decreased due to the decreased connection interval.

Optionally or alternatively, an adjustment of the connection interval can be forbidden for certain conditions. For example, the user equipment may periodically scan he 2.4 GHz band for activity. If there is strong interference, the handshake for reducing the connection interval might be delayed by retransmissions. Hence it might be beneficial to remain the connection interval at the predefined value, e.g., at 30 ms. Further, the interference can be used to predictively reduce the connection interval if the connection interval was increased before.

Optionally or alternatively, even without a trigger the connection interval can be increased if the user equipment determines that the communication device is in physical proximity. The determination of the physical proximity can be based on relative signal strength indicator. For example, a BLE fingerprinting allows for thresholds, or more advanced algorithms, to decide whether the user equipment is close to the vehicle. Optionally, the determination of the physical proximity can be based on channel sounding (phase-based, e.g., mode 2). Via channel sounding the approximate distance (measurement uncertainty less than 1 m) can be determined. A threshold, e.g., 10 m, can serve as proximity measure to the communication device.

Further, as there is the possibility of living next to the communication device (e.g., distance smaller 10 m), it might be beneficial to use both received signal strength indicator and channel sounding at the same time to increase reliability of the determination of the physical proximity.

As described above, if motion stops 310 and there is no active BLE communication (e.g., no non-empty BLE packets are received at the user equipment), the user equipment can check after a timeout (e.g., 2 min), whether the user equipment is in physical proximity to the communication device. If the user equipment is in physical proximity to the communication device, the timeout may reset and another vehicle proximity check follows after the timeout.

More details and aspects are mentioned in connection with the embodiments described above and/or below. The example shown in FIG. 3 may comprise one or more optional additional features corresponding to one or more aspects mentioned in connection with the proposed concept or one or more examples described above (e.g., FIGS. 1-2) and/or below (e.g., FIG. 4).

FIG. 4 shows a block diagram of an example of an apparatus 30 for a vehicle 40. The apparatus 30 comprises interface circuitry 32 configured to communicate with a communication device and/or user equipment or backend and processing circuitry 34 configured to perform a method as described above, e.g., the method for user equipment as described with reference to FIG. 1 or the method for a communication device as described with reference to FIG. 2. For example, the apparatus 30 may be part of the vehicle 40, e.g., part of a control unit of the vehicle 40.

For example, the vehicle 40 may be a land vehicle, such a road vehicle, a car, an automobile, an off-road vehicle, a motor vehicle, a bus, a robo-taxi, a van, a truck or a lorry. Alternatively, the vehicle 40 may be any other type of vehicle, such as a train, a subway train, a boat or a ship. For example, the proposed concept may be applied to public transportation (trains, bus) and future means of mobility (e.g., robo-taxis).

As shown in FIG. 4 the respective interface circuitry 32 is coupled to the respective processing circuitry 34 at the apparatus 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the interface circuitry 32, so that any data transfer that occurs over the interface circuitry 32 and/or any interaction in which the interface circuitry 32 may be involved may be controlled by the processing circuitry 34.

In an embodiment the apparatus 30 may comprise a memory and at least one processing circuitry 34 operably coupled to the memory and configured to perform the method described above.

In examples the interface circuitry 32 may correspond to any means for obtaining, receiving, transmitting or providing analog or digital signals or information, e.g. any connector, contact, pin, register, input port, output port, conductor, lane, etc. which allows providing or obtaining a signal or information. The interface circuitry 32 may be wireless or wireline and it may be configured to communicate, e.g., transmit or receive signals, information with further internal or external components.

The apparatus 30 may be a computer, processor, control unit, (field) programmable logic array ((F) PLA), (field) programmable gate array ((F) PGA), graphics processor unit (GPU), application-specific integrated circuit (ASICs), integrated circuits (IC) or system-on-a-chip (SoCs) system.

More details and aspects are mentioned in connection with the embodiments described. The example shown in FIG. 4 may comprise one or more optional additional features corresponding to one or more aspects mentioned in connection with the proposed concept or one or more examples described above (e.g., FIGS. 1-3).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

If some aspects have been described in relation to a device or system, these aspects should also be understood as a description of the corresponding method and vice versa. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

The aspects and features described in relation to a particular one of the previous examples may also be combined with one or more of the further examples to replace an identical or similar feature of that further example or to additionally introduce the features into the further example.

### REFERENCES

30 apparatus
32 processing circuitry
34 interface circuitry
40 vehicle
100 method for user equipment for adjusting a Bluetooth Low Energy connection interval
110 obtaining connection data
120 adjusting the connection interval
200 method for communication device for adjusting a Bluetooth Low Energy connection interval
210 receiving an adjustment signal
220 adjusting the connection event interval
310 motion stop
320 proximity check
330 proximity check

1-10. (canceled)

11. A method for user equipment for adjusting a Bluetooth Low Energy connection interval with a communication device, the method comprising:
obtaining connection data indicative of a desired adjustment of the connection interval; and
adjusting the connection interval between the user equipment and the communication device based on the connection data.

12. The method according to claim 11, wherein the connection data is indicative of at least one of:
a distance between the user equipment and the communication device,
a location of the user equipment,
a location of the communication device,
an interference of the communication between the user equipment and the communication device, or
a motion of the user equipment.

13. The method according to claim 11, further comprising:
determining the desired adjustment based on a distance between the user equipment and the communication device;
obtaining distance data indicative of a distance between the user equipment and the communication device; and
comparing the distance data with a threshold and adjusting the connection interval if the threshold is exceeded or undercut.

14. The method according to claim 11, wherein:
the connection interval is increased or decreased based on the connection data.

15. The method according to claim 11, further comprising:
obtaining usage data indicative of a usage of the adjusted connection interval; and
resetting the connection interval based on the usage data.

16. The method according to claim 11, further comprising:
transmitting an adjustment signal indicative of the adjustment of the connection interval to the communication device.

17. A method for a communication device for adjusting a Bluetooth Low Energy connection interval with user equipment, the method comprising:
receiving an adjustment signal indicative of an adjustment of the connection interval from the user equipment; and
adjusting the connection event interval between the user equipment and the communication device based on the adjustment signal.

18. An apparatus, comprising:
interface circuitry configured to communicate with at least one of a communication device or user equipment; and
processing circuitry configured to perform a method according to claim 11.

19. A vehicle comprising the apparatus according to claim 18.

20. A computer-readable storage medium storing a computer program code that when executed by one or more processors, cause the one or more processors to perform the method of claim 11.
